(19) United States
(12) Patent Application Publication
(10) Pub. No.: US 2023/0299624 A1
(43) Pub. Date: Sep. 21, 2023

(54) STATOR FOR DISK MOTOR, STATOR SUPPORTING RING AND COMPRESSOR

(71) Applicant: Danfoss (Tianjin) Ltd., Tianjin (CN)

(72) Inventors: Wanzhen LIU, Tianjin (CN); Yusong SUN, Tianjin (CN); Yan LIN, Tianjin (CN); Li YAO, Tianjin (CN)

(21) Appl. No.: 18/005,995

(22) PCT Filed: Jun. 4, 2021
(86) PCT No.: PCT/CN2021/098291

§ 371 Date: Jan. 19, 2023

(30) Foreign Application Priority Data
Jul. 20, 2020 (CN) 202010698083.1
Jul. 20, 2020 (CN) 202021427487.9

(51) Int. Cl. H02K 1/18; H02K 1/14; F25B 31/02

(52) U.S. Cl. CPC H02K 1/182; H02K 1/148; F25B 31/02

(57) ABSTRACT

A stator for a disk motor, a stator supporting ring and a compressor belong to the field of refrigeration technology. The stator includes a ring-shaped stator core including a plurality of ring-shaped or arc-shaped layers of magnetically conductive materials laminated on each other in a radial direction. In addition, the stator supporting ring is configured to fix a stator for a disk motor and has an inner wall fitted over a stator yoke of the stator. The compressor includes: a shell; a compression unit fixed within the shell; and a disk motor coupled with the compression unit. The disk motor includes: a rotor, and at least one stator fixed to the shell by the stator supporting ring.

### CROSS-REFERENCE TO RELATED APPLICATIONS

This application is a National Stage application of International Patent Application No. PCT/CN2021/098291, filed on Jun. 4, 2021, which claims priority to Chinese Patent Applications No. 202010698083.1, filed on Jul. 20, 2020, and No. 202021427487.9, filed Jul. 20, 2020, each of which is hereby incorporated by reference in its entirety.

### TECHNICAL FIELD

The present disclosure relates to the field of refrigeration technology, and in particular, to a stator for a disk motor, a stator supporting ring and a compressor.

### BACKGROUND

An axial flux motor differs from a radial flux motor in that the axial flux motor has an axial direction of magnetic flux and includes a stator and a rotor which are both is in a disk shape and which are arranged along an axial direction. Therefore, the axial flux motor is also called a disk motor. Because the stator of the disk motor is flat, the contact area between the stator and a shell of a compressor is small if the stator is installed in the shell; besides, there is a large axial electromagnetic attraction between the stator and the rotor; thus, there is a risk of unreliable fixing of the disk motor in the compressor.

### SUMMARY

It is an object of the present disclosure is to solve at least one aspect of the above-mentioned problems and defects in the related art.

According to an aspect of the present disclosure, there is provided a stator for a disk motor. The stator includes a ring-shaped stator core including a plurality of ring-shaped or arc-shaped layers of magnetically conductive materials laminated on each other in a radial direction.

In an embodiment, each layer of the magnetically conductive material in the plurality of layers of the magnetically conductive materials is formed by splicing at least two arc-shaped magnetically conductive materials, and splices of adjacent ones of the plurality of layers are staggered from each other, and the splices correspond in position to stator slots.

In an embodiment, the stator core further includes a stator yoke and a stator tooth, and the stator yoke is fixedly connected at its outer side with a stator supporting ring.

In an embodiment, the stator yoke is provided with a radial mounting hole, and the stator yoke and the stator supporting ring are fixedly connected by inserting a bolt or fin into the radial mounting hole.

In an embodiment, the stator supporting ring is provided with a first mounting hole for axially fixing the stator; or the stator supporting ring is fixed to the stator yoke by interference fit.

In an embodiment, the stator core includes a plurality of arc-shaped modules, adjacent ones of the plurality of arc-shaped modules are circumferentially positioned and connected by inserting a bolt or fin on an inner flange into a radial mounting hole in the stator yoke.

In an embodiment, the magnetically conductive material includes a soft magnetic material or a silicon steel sheet; and the inner flange and the bolt or fin on the inner flange are integral or separate parts.

In an embodiment, the magnetically conductive material includes a silicon steel sheet.

According to another aspect of the present disclosure, there is provided a stator supporting ring configured to fix a stator for a disk motor and having an inner wall fitted over a stator yoke of the stator, wherein the stator supporting ring is fitted over the stator yoke by interference fit, clearance fit or welding.

In an embodiment, an end face of the stator supporting ring is provided with a plurality of axial first mounting holes for fixing the stator for the disk motor to a shell of a compressor; or the stator supporting ring is integrated with a stator supporter to fix the stator for the disk motor to the shell of the compressor.

In an embodiment, the stator is the stator according to any one of abovementioned embodiments.

In an embodiment, the stator includes a ring-shaped stator core including a plurality of arc-shaped modules.

In an embodiment, a stator core of the stator is formed by punching and winding a silicon steel strip.

In an embodiment, a stator core of the stator is formed of a silicon steel strip by a single-slot punching technology.

In an embodiment, an end of the stator supporting ring in contact with the stator yoke has a single-sided boss structure or a double-sided boss structure in an axial direction.

In an embodiment, the stator supporting ring is fitted over the stator yoke by clearance fit, wherein a plurality of radial second mounting holes are provided in an outer wall of the stator supporting ring, and the stator supporting ring and the stator yoke are fixed together by cooperation of bolts or rivets and the second mounting holes.

In an embodiment, the second mounting holes and the first mounting holes are alternately arranged along a circumference of the stator supporting ring.

In an embodiment, the stator supporting ring has a circular ring shape with a uniform radial width.

In an embodiment, the stator supporting ring has a ring shape with lug structures evenly or unevenly distributed along a circumferential direction of the stator supporting ring, each of the lug structures is provided with the first mounting hole, and the second mounting hole is provided in a position between two adjacent ones of the lug structures.

In an embodiment, each of the first mounting holes corresponds to one stator slot of the disk motor in a radial direction.

In an embodiment, the stator is axially fixed with the stator supporter by bolts through the stator supporting ring, and the stator supporter is in an interference fit with a shell of the compressor to which the disk motor is mounted; or the stator is axially fixed with the stator supporter by bolts through the stator supporting ring, and the stator supporter is integrated with the shell of the compressor to which the disk motor is mounted; or the stator supporting ring and the stator supporter are integral, and outer sidewalls of the stator supporting ring and the stator supporter are in an interference fit with the shell of the compressor to which the disk motor is mounted.

According to still another aspect of the present disclosure, there is provided a compressor, including: a shell; a compression unit fixed within the shell; and a disk motor coupled with the compression unit, the disk motor including: a rotor, and at least one stator according to any one of abovementioned embodiments fixed to the shell by the stator supporting ring according to any one of abovementioned embodiments; wherein the at least one stator is provided on an axial side of the rotor, the compression unit is opposite to a stator yoke of the at least one stator in an axial direction, the rotor is opposite to a stator tooth of the at least one stator, the at least one stator is fixedly connected with a stator supporter through the stator supporting ring in the axial direction, and the stator supporter is in an interference fit with the shell of the compressor or is an integral part with the shell of the compressor.

In an embodiment, the stator supporting ring has a ring shape with lug structures unevenly distributed along a circumferential direction of the stator supporting ring; each of the lug structures is provided with a first mounting hole for fixedly connecting the stator supporting ring to the stator supporter in the axial direction; and a second mounting hole is provided at a position between two adjacent ones of the lug structures to cooperate with a bolt or rivet to fix the stator supporting ring and the stator yoke together; wherein a distance between two lug structures on a side of the compressor opposite to a suction port of the compressor is larger than a distance between two lug structures on a side of the compressor on which the suction port is disposed.

### BRIEF DESCRIPTION OF THE DRAWINGS

In order to illustrate the technical solutions of the embodiments of the present disclosure more clearly, the accompanying drawings of the embodiments will be briefly described below. It should be understood that the drawings described below only relate to some embodiments of the present disclosure, but should not be construed as limiting the present disclosure.

FIGS. 1A and 1B are respectively a front view and a cross-sectional view of a stator and a stator supporting ring for a disk motor according to an embodiment of the present disclosure;

FIGS. 2A and 2B are respectively a front view and a cross-sectional view of a stator and a stator supporting ring for the disk motor according to another embodiment of the present disclosure,;

FIGS. 3A, 3B and 3C are respectively a front view, a cross-sectional view and a perspective view of a stator and a stator supporting ring for the disk motor according to another embodiment of the present disclosure;

FIGS. 4A, 4B, 4C and 4D, respectively show front views and cross-sectional views of four different modifications of the stator supporting ring for the disk motor according to the present disclosure;

FIGS. 5A and 5B respectively show front views and cross-sectional views of two different modifications of the stator supporting ring for the disk motor with a first mounting hole and a second mounting hole therein according to the present disclosure;

FIGS. 6A, 6B and 6C respectively show a front view, a cross-sectional view taken along the line A1-A1′ in FIG. 6A and a perspective view of the stator and the stator supporting ring for the disk motor according to a yet another embodiment of the present disclosure;

FIGS. 7A and 7B respectively show a view of a layer of a silicon steel sheet for the disk motor according to an embodiment of the present disclosure and a perspective view of a stator core formed by laminating a plurality of layers of the silicon steel sheets shown in FIG. 7A;

FIG. 7C is a schematic view showing a structure of splices of adjacent layers of silicon steel sheets;

FIG. 7D shows a schematic view of a fixed connection between the stator core and the stator supporting ring;

FIG. 7E shows a schematic view of an assembly of the stator core and the stator supporting ring fixed by an inner flange;

FIG. 7F shows a schematic view of a connection between the inner flange and fins or between the inner flange and bolts;

FIG. 7G shows a schematic exploded view of the stator core in the form of modules;

FIG. 7H shows a schematic view of the stator core formed by fixed connection through the inner flange; and

FIGS. 8A, 8B and 8C show a view of a part of a compressor with the stator mounted therein according to an embodiment of the present disclosure, a view of a part of the compressor with the stator mounted therein according to a modification, and a view of a part of the compressor with two stators mounted therein according to an example, respectively.

### DETAILED DESCRIPTION

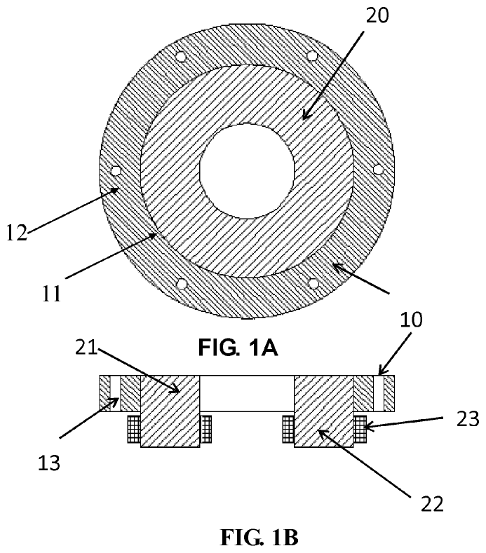

The technical solutions of the present disclosure will be further described in detail below through embodiments with reference to FIGS. 1A-8C. In this description, the same or similar elements are indicated by the same or similar reference signs. The following description of the embodiments of the present disclosure with reference to the accompanying drawings is intended to explain the general inventive concept of the present disclosure, and should not be construed as a limitation of the present disclosure.

A stator supporting ring, a stator and a compressor according to embodiments of the present disclosure will be described below with reference to the accompanying drawings.

Referring to FIGS. 1A and 1B, a stator supporting ring 10 is configured to fix a stator 20 of a disk motor and has an inner wall 11 fitted over a stator yoke 21 of the stator 20. A plurality of axial first mounting holes 13 are provided in an end face 12 of the stator supporting ring 10, and the first mounting holes 13 are configured for fixing the stator 20 of the disk motor in an axial direction. The stator 20 further includes a stator tooth 22 and a winding 23 wound around the stator tooth 22.

Alternatively, an outer end face of the stator supporting ring 10 has an interference area that is large enough to allow the stator supporting ring 10 to be directly in an interference fit with a shell of the compressor, without provision of the first mounting hole 13.

As shown in the figures, the stator supporting ring 10 includes a circular ring-shaped body. In other words, the body has substantially the same width or same radial length along a radial direction. That is, the stator supporting ring 10 is a circular ring or a circular ring shape having a uniform radial width.

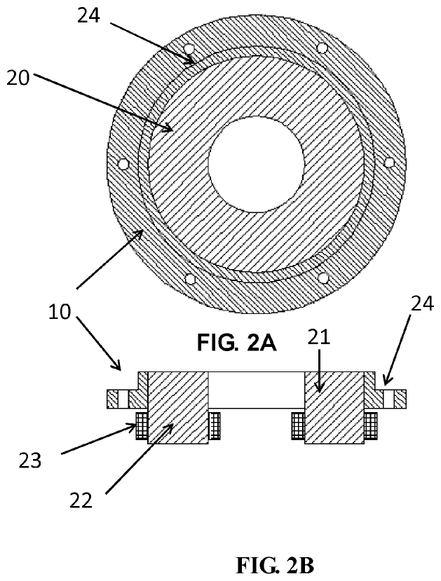

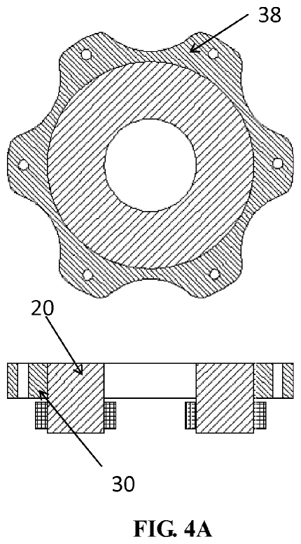

The stator supporting ring 10 may also be configured in other forms. For example, as shown in FIGS. 2A and 2B, the stator supporting ring 10 has a single-sided boss structure 24 in the axial direction at an end of the stator supporting ring 10 that is in contact with the stator yoke 21. That is, at least one step is provided on the stator supporting ring 10. With such a design, the stator supporting ring 10 can have a more compact structure and a reduced weight. The stator supporting ring 10 may also be configured in the form as shown in FIG. 4C. The stator supporting ring 10 has a double-sided boss structure 35 in the axial direction at the end of the stator supporting ring 10 in contact with the stator yoke 21. That is, the stator supporting ring 10 has a T-shape rotated by 90°.

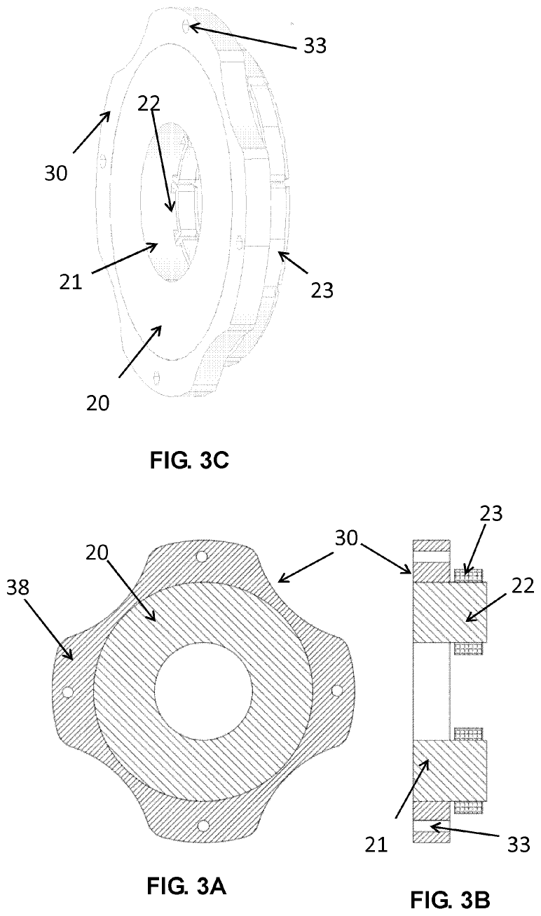

As shown in FIGS. 3A, 3B and 3C, an example of a stator supporting ring 30 with a lug structure is shown, instead of the stator supporting ring 10 in the form of the circular ring as shown in FIGS. 1A, 1B, 2A and 2B. The stator supporting ring 30 is provided with four lug structures 38 which are evenly distributed along a circumferential direction of the stator supporting ring 30. The size of the lug structure 38 may be set as required and is not limited to the illustrated situation.

FIGS. 4A, 4B and 4C respectively show a stator supporting ring 30 having no step, a stator supporting ring 30 having a protruding structure 34 on one side, and a stator supporting ring 30 having protruding structures 35 on both sides. However, the difference between the stator supporting rings shown in FIGS. 4A, 4B and 4C and those shown in FIGS. 1A and 1B is that the main body of each of the stator supporting rings shown in FIGS. 4A, 4B and 4C does not have a circular ring shape but has a ring shape with a lug structure. Specifically, the stator supporting ring 30 has a ring shape with the lug structures evenly distributed along a circumferential direction of the stator supporting ring 30. As shown in FIGS. 4A, 4B and 4C, the stator supporting ring 30 is provided with six lug structures 38. However, it should be understood that those skilled in the art will set any number of lug structures according to the specific situation, and the stator supporting ring 30 is not limited to the illustrated situation.

In addition, the lug structures 38 on the stator supporting ring 30 may also be unevenly distributed along the circumferential direction of the stator supporting ring 30, as shown in FIG. 4D. A distance between two lug structures 38 on a side of the compressor opposite to a suction port of the compressor is larger than a distance between two lug structures 38 on a side of the compressor on which the suction port is disposed (i.e., the distance between the two lug structures 38 on the side opposite to the suction port is larger than the distance between the two lug structures 38 on the suction port side). In this way, the side opposite to the suction port can be made closer to the suction port of the compressor, so that more refrigerant can be sucked.

Regardless of the form of the stator supporting ring 10 or 30, it may be fitted over the stator yoke 21 by interference fit or welding.

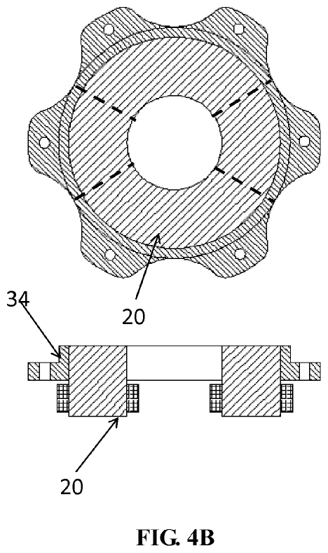

In addition, as shown in FIGS. 5A and 5B, the stator supporting ring 30 may also be fitted over the stator yoke 21 by clearance fit. A plurality of radial second mounting holes 36 are provided in an outer wall of the stator supporting ring 30, and the stator supporting ring 30 and the stator yoke 21 are fixed together by the cooperation of bolts or rivets 37 and the second mounting holes 36. FIG. 5B shows an example in which the stator supporting ring 30 having the boss structure 34 on the single side is provided with the second mounting holes 36, but not showing the stator supporting ring 30 having the second mounting holes 36 as well as the boss structures on both sides.

It can be understood that the circular ring-shaped stator supporting ring 10 may also be similarly provided with the second mounting holes, which is not illustrated herein.

Further, as shown, the second mounting holes 36 and the first mounting holes 13 may be alternately arranged along a circumference of the stator supporting ring 30. For example, six second mounting holes 36 and six first mounting holes 13 are alternately distributed along the circumference of the stator supporting ring 30 in sequence. It can be understood that the numbers and arrangements of the first mounting holes and the second mounting holes are not limited to the foregoing, and may be configured by those skilled in the art as required.

In FIGS. 5A and 5B, the stator supporting ring 30 has the ring shape with the lug structures 38 evenly distributed along the circumferential direction of the stator supporting ring 30, each lug structure 38 is provided with the first mounting hole 13, and the second mounting hole 36 is provided at a position between two adjacent lug structures 38.

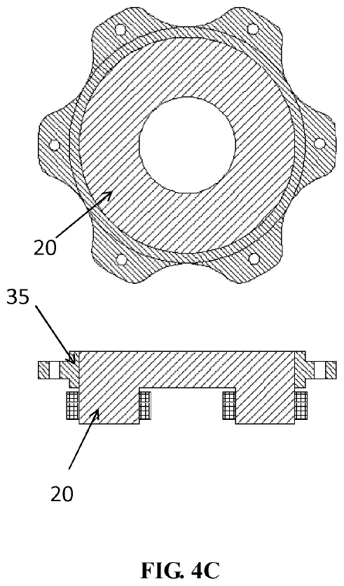

As shown in FIGS. 6A, 6B and 6C, each of the first mounting holes 13 corresponds to one stator slot 28 of the disk motor in a radial direction. That is, the first mounting holes 13 is in one-to-one correspondence with the stator slots 28 in the left-right direction along the page where FIG. 6C is presented.

As described above, the stator for the disk motor may be the stator described in the above embodiments, and alternatively may also be the stator described in the following embodiments.

Further, the stator supporting ring of the present disclosure can be used not only with various stators described in the present disclosure, but also with any known stators of any type or structure for disk motors.

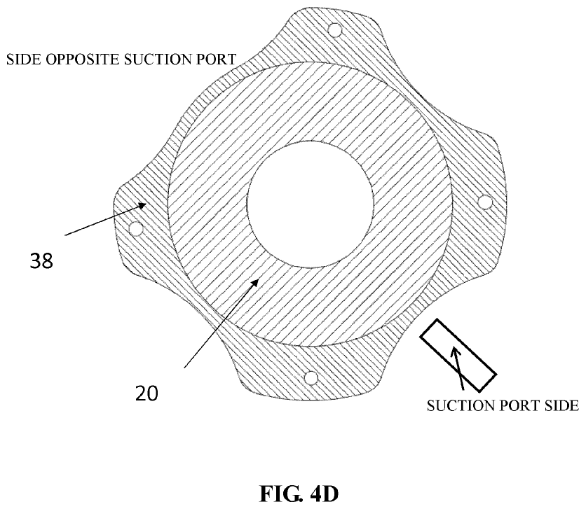

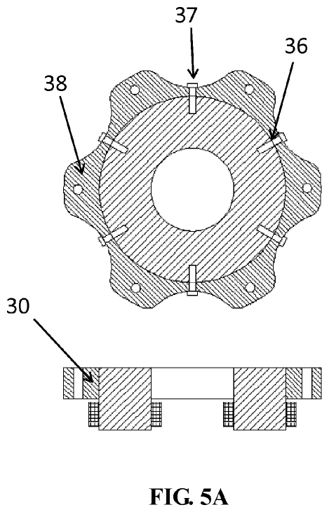

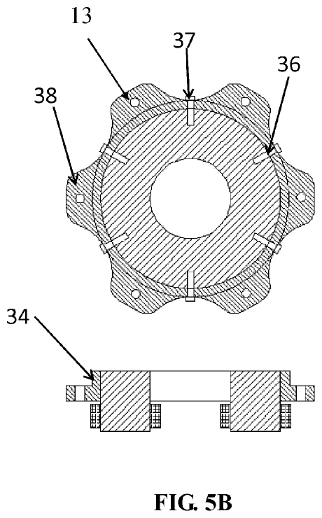

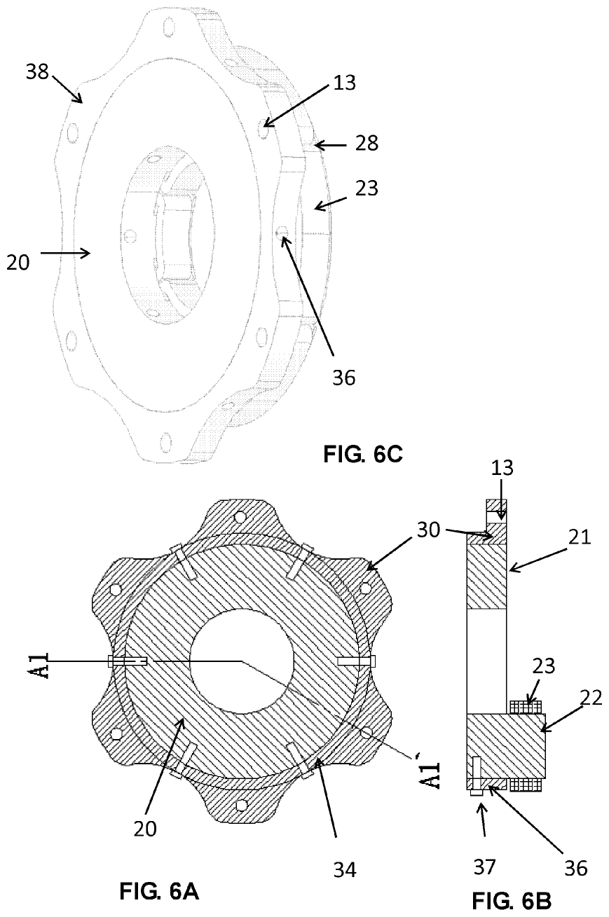

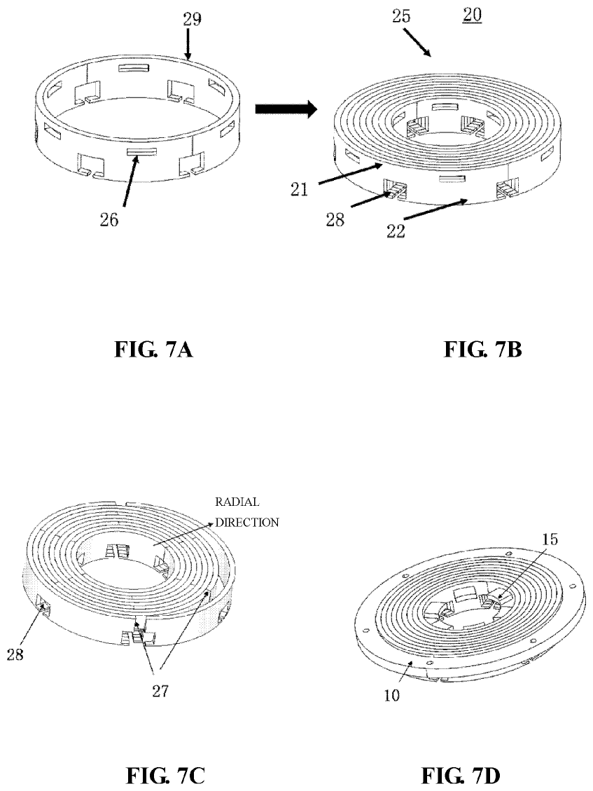

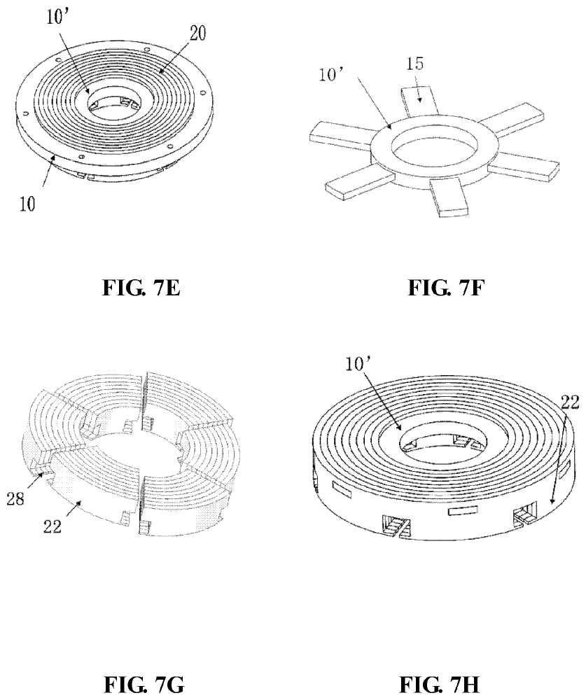

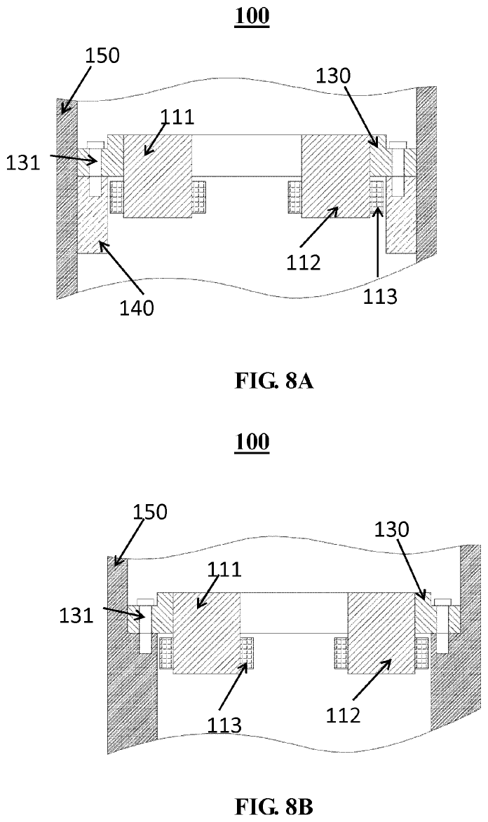

Specifically, referring to FIGS. 7A and 7B, a stator 20 for the disk motor according to another embodiment of the present disclosure is shown. The stator 20 includes a ring-shaped stator core 25, and the stator core 25 includes a plurality of ring-shaped or arc-shaped layers of silicon steel sheets 29 laminated on each other in a radial direction. An example of the silicon steel sheet is shown in this example, and it can be understood that the stator core 25 may be made of any suitable type of magnetically conductive material and is not limited to the silicon steel sheet.

With such a structure, the potential risk of scrapping the stator as a whole is avoided. In addition, due to the high magnetic permeability of the silicon steel sheet, the problem of an increase in current is avoided.

FIG. 7A shows a single layer of the silicon steel sheet. A plurality of layers of the silicon steel sheets are laminated in a radial direction or a lamination direction to form the stator 20 shown in FIG. 7B, and the stator is further provided with radial mounting holes 26.

Referring to FIG. 7C, each layer of the silicon steel sheet 29 is formed by splicing at least two arc-shaped silicon steel sheets, and splices 27 of adjacent layers are staggered from each other, and the splices 27 correspond in position to the stator slots 28. Specifically, in one example, the splice 27 may be at the center of the stator slot 28, or may be along an axial direction of the stator and offset by a distance along a rotational direction of a rotor.

As shown in FIGS. 7B and 7D, the stator core further includes a stator yoke 21 and a stator tooth 22, and the stator yoke 21 is fixedly connected to the stator supporting ring 10 outside the stator yoke.

Specifically, the stator yoke 21 and the stator supporting ring 10 are fixedly connected by inserting bolts or fins 15 into the radial mounting holes 26 in the stator yoke 21.

Specifically, the stator supporting ring 10 is provided with the first mounting holes 13 for axially fixing the stator.

Referring to FIGS. 7E and 7F, the inner flange 10′ and the bolts or fins 15 on the inner flange 10′ are integral or separate parts.

Referring to FIG. 7G, in a further embodiment of the present disclosure, the stator core 25 may be formed by splicing a plurality of arc-shaped modules. Each module is an integrally formed module, and the material of the module may be made of soft magnetic material such as SMC (sheet molding compound) or silicon steel sheet. Adjacent arc-shaped modules are circumferentially positioned and connected by inserting the bolts or fins 15 on the inner flange 10′ into the radial mounting holes (not shown in FIG. 7G).

Each module is sequentially mounted to the fins or bolts 15 to form the stator core 25, as shown in FIG. 7H.

As shown in FIG. 7H, the bolt 15 is inserted into the radial mounting hole 26 from the inner side of the stator core 25, but the radial mounting hole 26 extends through only a part of the stator supporting ring. In other words, the radial mounting hole 26 does not penetrate the stator supporting ring completely. Those skilled in the art can select the length and size of the radial mounting hole 26 as required. For example, the radial mounting hole 26 may also be designed to penetrate the stator supporting ring, so that the bolt 15 can also be inserted from the outside.

Since a direction of a magnetic field in the stator yoke mostly changes along the circumferential direction of the stator yoke, which is parallel to the plane where the bolts or fins are located, the generation of electromagnetic induction current can be avoided even if the bolts or fins are connected to each other, and the purpose of fixation and supporting is achieved without adversely affecting the performance of the motor.

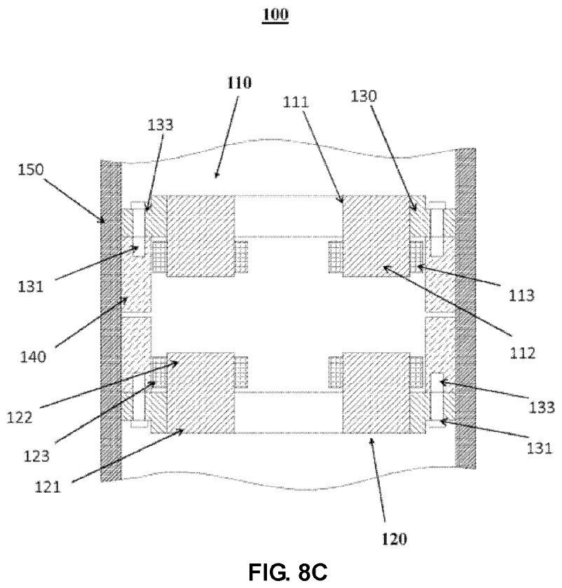

In FIGS. 8A, 8B and 8C, a compressor 100 is shown which includes a shell 150, a compression unit (not shown) and a disk motor. The disk motor is coupled to the compression unit, and the disk motor includes a rotor (not shown), a first stator 110 and a second stator 120. The first stator 110 and the second stator 120 are fixed by stator supporting rings 130, respectively. The stator supporting ring 130 may be the stator supporting ring 10 or 30 described in any of the above embodiments. The compressor may be a scroll compressor, in which the compression unit is a compression unit formed by scrolls.

Referring specifically to FIG. 8C, the first stator 110 and the second stator 120 are respectively provided on both sides of the rotor in an axial direction, and the compression unit is opposite to stator yokes 111 and 121 of the first stator 110 and the second stator 120 in the axial direction, and the rotor is provided in a space formed between the first stator 110 and a stator supporter 140 of the first stator 110 and between the second stator 120 and a stator supporter 140 of the second stator 120 in the axial direction. The rotor is opposite to stator teeth 112 and 122 of the first stator 110 and the second stator 120, and the first stator 110 and the second stator 120 are respectively fixedly connected to corresponding stator supporters 140 in the axial direction through the respective stator supporting rings 130, and the corresponding stator supporters 140 are respectively in an interference fit with the shell 150 of the compressor 100.

Specifically, the first stator 110 includes a stator yoke 111, a stator tooth 112 and a winding 113 wound around the stator tooth 112. Similarly, the second stator 120 includes a stator yoke 121, a stator tooth 122 and a winding 123 wound around the stator tooth 122.

Specifically, as shown in FIGS. 8A and 8C, the stator supporter 140 is a separate component from the shell 150, and the stator supporting ring 130 is fixedly connected to the stator supporter 140 by inserting the bolts 131 into the first mounting holes 133.

As shown in FIG. 8B, the stator supporter 140 may be a part of the shell, that is, a component of the shell. As shown, a part of the shell 150 is provided in the form of a step, which functions for supporting the stator supporting ring 130.

In the present disclosure, the stator supporting ring is mounted on the outer side of the stator yoke, and the stator supporting ring and the stator supporter are fixedly connected together by fixing parts such as bolts, thereby realizing the axial fixation of the disk motor stator. It can be understood that the stator supporting ring and the stator supporter may also be fixedly connected together in other connectional manners, such as by interference fit or welding. The interference area of the stator supporter in the axial direction is larger than the area of the stator yoke in the axial direction. For example, the interference area of the stator supporter in the axial direction is greater than or equal to 1.5 times the area of the stator yoke in the axial direction. The stator supporting ring may also be directly in an interference fit with the shell of the compressor without using the stator supporter, under appropriate circumstances.

Although the situation that two stators are provided on both sides of one rotor, respectively, has been described above, it may also be designed that one rotor corresponds to one stator, and the numbers of rotors and stators in the compressor are not limited to the situation shown in the figures, and can be chosen by those skilled in the art as required.

In the embodiments of the present disclosure, an axial disk motor and a compressor using such a disk motor have been taken as an example to illustrate. However, those skilled in the art can understand that the compressor may be a vertical compressor or a horizontal compressor. Likewise, the compressor can be a single-cylinder compressor or a multi-cylinder compressor.

Only some embodiments of the present disclosure have been described above, and those skilled in the art will understand that changes can be made to these embodiments without departing from the principles and spirit of the general inventive concept, and the scope of the present disclosure is defined by the claims and their equivalents.

1. A stator for a disk motor, comprising a ring-shaped stator core comprising a plurality of ring-shaped or arc-shaped layers of magnetically conductive materials laminated on each other in a radial direction.

2. The stator for the disk motor according to claim 1, wherein
each layer of the magnetically conductive material in the plurality of layers of the magnetically conductive materials is formed by splicing at least two arc-shaped magnetically conductive materials, and splices of adjacent ones of the plurality of layers are staggered from each other, and the splices correspond in position to stator slots.

3. The stator for the disk motor according to claim 2, wherein
the stator core further comprises a stator yoke and a stator tooth, and the stator yoke is fixedly connected at its outer side with a stator supporting ring.

4. The stator for the disk motor according to claim 3, wherein
the stator yoke is provided with a radial mounting hole, and the stator yoke and the stator supporting ring are fixedly connected by inserting a bolt or fin into the radial mounting hole.

5. The stator for the disk motor according to claim 3, wherein
the stator supporting ring is provided with a first mounting hole for axially fixing the stator; or the stator supporting ring is fixed to the stator yoke by interference fit.

6. The stator for the disk motor according to claim 3, wherein
the stator core comprises a plurality of arc-shaped modules, adjacent ones of the plurality of arc-shaped modules are circumferentially positioned and connected by inserting a bolt or fin on an inner flange into a radial mounting hole in the stator yoke.

7. The stator for the disk motor according to claim 6, wherein
the magnetically conductive material comprises a soft magnetic material or a silicon steel sheet; and the inner flange and the bolt or fin on the inner flange are integral or separate parts.

8. The stator for the disk motor according to claim 1, wherein the magnetically conductive material comprises a silicon steel sheet.

9. A stator supporting ring configured to fix a stator for a disk motor and having an inner wall fitted over a stator yoke of the stator, wherein the stator supporting ring is fitted over the stator yoke by interference fit, clearance fit or welding.

10. The stator supporting ring according to claim 9, wherein
an end face of the stator supporting ring is provided with a plurality of axial first mounting holes for fixing the stator for the disk motor to a shell of a compressor; or
the stator supporting ring is integrated with a stator supporter to fix the stator for the disk motor to the shell of the compressor.

11. The stator supporting ring according to claim 10, wherein
the stator comprises a ring-shaped stator core comprising a plurality of ring-shaped or arc-shaped layers of magnetically conductive materials laminated on each other in a radial direction.

12. The stator supporting ring according to claim 10, wherein
the stator comprises a ring-shaped stator core comprising a plurality of arc-shaped modules.

13. The stator supporting ring according to claim 10, wherein
a stator core of the stator is formed by punching and winding a silicon steel strip, or formed of a silicon steel strip by a single-slot punching technology.

14. (canceled)

15. The stator supporting ring according to claim 10, wherein
an end of the stator supporting ring in contact with the stator yoke has a single-sided boss structure or a double-sided boss structure in an axial direction.

16. The stator supporting ring according to claim 10, wherein
the stator supporting ring is fitted over the stator yoke by clearance fit, wherein a plurality of radial second mounting holes are provided in an outer wall of the stator supporting ring, and the stator supporting ring and the stator yoke are fixed together by cooperation of bolts or rivets and the second mounting holes.

17. The stator supporting ring according to claim 16, wherein
the second mounting holes and the first mounting holes are alternately arranged along a circumference of the stator supporting ring.

18. The stator supporting ring according to claim 16, wherein
the stator supporting ring has a circular ring shape with a uniform radial width.

19. The stator supporting ring according to claim 16, wherein
the stator supporting ring has a ring shape with lug structures evenly or unevenly distributed along a circumferential direction of the stator supporting ring, each of the lug structures is provided with the first mounting hole, and the second mounting hole is provided in a position between two adjacent ones of the lug structures.

20. The stator supporting ring according to claim 10, wherein
each of the first mounting holes corresponds to one stator slot of the disk motor in a radial direction.

21. The stator supporting ring according to claim 10, wherein
the stator is axially fixed with the stator supporter by bolts through the stator supporting ring, and the stator supporter is in an interference fit with a shell of the compressor to which the disk motor is mounted; or
the stator is axially fixed with the stator supporter by bolts through the stator supporting ring, and the stator supporter is integrated with the shell of the compressor to which the disk motor is mounted; or
the stator supporting ring and the stator supporter are integral, and outer sidewalls of the stator supporting ring and the stator supporter are in an interference fit with the shell of the compressor to which the disk motor is mounted.

22. A compressor, comprising:
a shell;
a compression unit fixed within the shell; and
a disk motor coupled with the compression unit, the disk motor comprising: a rotor, and at least one stator according to claim 1 fixed to the shell by the stator supporting ring configured to fix a stator for a disk motor and having an inner wall fitted over a stator yoke of the stator, wherein the stator supporting ring is fitted over the stator yoke by interference fit, clearance fit or welding;
wherein the at least one stator is provided on an axial side of the rotor, the compression unit is opposite to a stator yoke of the at least one stator in an axial direction, the rotor is opposite to a stator tooth of the at least one stator, the at least one stator is fixedly connected with a stator supporter through the stator supporting ring in the axial direction, and the stator supporter is in an interference fit with the shell of the compressor or is an integral part with the shell of the compressor.

23. The compressor according to claim 22, wherein
the stator supporting ring has a ring shape with lug structures unevenly distributed along a circumferential direction of the stator supporting ring;
each of the lug structures is provided with a first mounting hole for fixedly connecting the stator supporting ring to the stator supporter in the axial direction; and
a second mounting hole is provided at a position between two adjacent ones of the lug structures to cooperate with a bolt or rivet to fix the stator supporting ring and the stator yoke together;
wherein a distance between two lug structures on a side of the compressor opposite to a suction port of the compressor is larger than a distance between two lug structures on a side of the compressor on which the suction port is disposed.
